(19) United States
(12) Patent Application Publication
(10) Pub. No.: US 2025/0335740 A1
(43) Pub. Date: Oct. 30, 2025

(54) MACHINE LEARNING BASED APPROACH FOR AUTOMATICALLY RECOMMENDING CONTEXT-SPECIFIC NAVIGATION OPTIONS WITHIN A USER INTERFACE

(71) Applicant: INTUIT INC., Mountain View, CA (US)

(72) Inventors: Siddharth JAIN, Mountain View, CA (US); Venkat Narayan VEDAM, Mountain View, CA (US)

(21) Appl. No.: 18/651,460

(22) Filed: Apr. 30, 2024

(51) Int. Cl. G06N 3/042; G06N 3/0442; G06N 5/022

(52) U.S. Cl. CPC G06N 3/042; G06N 3/0442; G06N 5/022

(57) ABSTRACT

A method for automatically recommending navigation actions within a user interface of a software application includes: generating a knowledge graph comprising a plurality of nodes and a plurality of edges, each of the plurality of nodes representing a different user interface element of a plurality of user interface elements of the user interface, each of the edges representing a relationship among two or more nodes of the knowledge graph; receiving user action data associated with a user interacting with the user interface; dynamically updating the knowledge graph based on the user action data; determining a recommended navigation action based on the dynamically updated knowledge graph; and providing input to a generative language processing machine learning model based on the recommended navigation action, the input comprising a prompt requesting the generative language processing machine learning model generate natural language guidance indicative of the recommended navigation action.

### INTRODUCTION

Aspects of the present disclosure relate to user interfaces. In particular, aspects of the present disclosure relate to a machine learning based approach for automatically recommending context-specific navigation options within a user interface.

### BACKGROUND

Every year millions of people, businesses, and organizations around the world use software applications to help manage aspects of their lives. A software application may include a user interface that allows users to interact with the software application. The user interface may include user interface elements that users may select (e.g., click) to cause the software application to perform different functions. For example, a user may select a sequence of user interface elements to cause the software application to perform a specific function (e.g., generate an automated financial report).

A navigation error may occur when the user selects a user interface element that is not included in the sequence of user interface elements. The navigation error may result in an inefficient utilization of computing resources. For example, the navigation error may cause computing resources to be needlessly utilized to perform a different function of the software application. Conventional user interfaces do not understand the context of a user's actions with respect to selecting different user interface elements thereof and, as a result, cannot adaptively respond to user behavior. Furthermore, conventional user interfaces do not provide real-time adaptive guidance.

Accordingly, a need exists for machine learning based techniques for automatically recommending navigation options within a user interface that are specific to a user's actions (e.g., selection of one or more user interface elements) with respect to the user interface.

### BRIEF SUMMARY

Certain embodiments provide a method for automatically recommending navigation actions within a user interface of a software application. The method generally includes: generating a knowledge graph comprising a plurality of nodes and a plurality of edges, each of the plurality of nodes representing a different user interface element of a plurality of user interface elements of the user interface, each of the plurality of edges representing a relationship among two or more nodes of the knowledge graph; receiving user action data associated with a user interacting with the user interface; dynamically updating the knowledge graph based on the user action data; determining a recommended navigation action based on the dynamically updated knowledge graph; providing input to a generative language processing machine learning model based on the recommended navigation action, the input comprising a prompt requesting the generative language processing machine learning model generate natural language guidance indicative of the recommended navigation action; and displaying the natural language guidance to the user.

Other embodiments comprise systems configured to perform the method set forth above as well as non-transitory computer-readable storage mediums comprising instructions for performing the method set forth above.

The following description and the related drawings set forth in detail certain illustrative features of one or more embodiments.

### BRIEF DESCRIPTION OF THE DRAWINGS

The appended figures depict certain aspects of the one or more embodiments and are therefore not to be considered limiting of the scope of this disclosure.

FIG. 1 depicts an example computing environment for providing live support to a customer of a software application according to some aspects of the present disclosure.

FIG. 2 depicts a block diagram of components for automatically recommending navigation actions within a user interface of a software application according to some aspects of the present disclosure.

FIG. 3 depicts a flowchart of a method for automatically recommending navigation actions within a user interface of a software application according to some aspects of the present disclosure.

FIGS. 4A and 4B depict example processing systems according to some embodiments of the present disclosure.

To facilitate understanding, identical reference numerals have been used, where possible, to designate identical elements that are common to the drawings. It is contemplated that elements and features of one embodiment may be beneficially incorporated in other embodiments without further recitation.

### DETAILED DESCRIPTION

Aspects of the present disclosure provide apparatuses, methods, processing systems, and computer-readable mediums for automatically recommending context-specific navigation options within a user interface.

Example aspects of the present disclosure are directed to techniques for automatically recommending (e.g., in real-time) context-specific navigation actions within a user interface of a software application. For example, a user using the software application to perform a specific task may be automatically recommended a navigation action that allows the user to perform the specific task in a more efficient manner compared to conventional software applications. In this manner, by automatically recommending context-specific navigation actions within the user interface, the disclosed techniques may minimize (or at least reduce) the occurrence of navigation errors. Furthermore, by minimizing the occurrence of navigation errors, inefficient utilization of computing resources resulting from such navigation errors may be minimized (or at least reduced). Still further, in some embodiments, navigation action recommendations may be in response to a navigation error and therefore may assist a user in resolving the navigation error.

The disclosed techniques include generating a knowledge graph of the user interface. For example, the knowledge graph may include a plurality of nodes and a plurality of edges. Each of the plurality of nodes may represent a different user interface element of the user interface. Furthermore, each of the plurality of edges may represent a relationship between two or more nodes (e.g., user interface elements) of the plurality of nodes. In this manner, the knowledge graph may represent the different user interface elements, functionalities, and user actions that may be performed within the user interface.

In some embodiments, the structure of the knowledge graph may be analyzed through an adjacency matrix in which each element of the adjacency matrix reflects the existence of a relationship from one concept to another concept. In this manner, the adjacency matrix may facilitate the algorithmic identification of optimal paths and user intentions. Furthermore, search algorithms, such as Depth-First Search (DFS) or Breadth-First Search (BFS), having enhanced heuristic evaluations may be implemented to forecast the most efficient paths towards achieving user objectives.

In some embodiments, path efficiency may be evaluated by a cost function that assigns a real number (e.g., cost) to each of the plurality of edges in the knowledge graph. More specifically, the cost associated with each respective edge of the knowledge graph may be assigned a positive number, a negative number, or zero in an attempt to quantify resources required for the respective edge which, as previously mentioned, may represent an interaction between two or more user interface elements of the user interface.

The disclosed techniques include collecting user action data associated with the user interface. The user action data may indicate the different navigation paths (e.g., sequences of user interface elements) within the user interface that users take to perform certain tasks. For example, the user action data may indicate that users take a first navigation path within the user interface to perform a first task and take a second navigation path within the user interface to perform a second task that is different from the first task.

In some embodiments, the disclosed techniques may include providing the user action data as an input to a machine learning model configured to analyze the user action data to identify patterns in how the user interface is utilized by the different users. For instance, the machine learning model may be configured to identify common tasks for which users use the software application based on the user action data.

In some embodiments, the machine learning model may be configured to analyze the user action data to identify inefficiencies associated with how the user interface is utilized to perform those common tasks the machine learning model identified based on the user action data. For example, the machine learning model may determine that a default navigation path of the user interface that a majority of users take to perform a common task (e.g., generate an automated report) may be inefficient compared to an alternative navigation path that exists within the user interface. More specifically, the alternative navigation path may include fewer user interface elements compared to the default navigation path. In this manner, the likelihood of navigation errors occurring when users perform the common task may be minimized (or at least reduced) by users traversing the alternative navigation path within the user interface instead of the default navigation path within the user interface.

In some embodiments, the machine learning model may be a hybrid neural network that includes spatial pattern recognition model such as a convolutional neural network (CNN) and a temporal sequence analysis model such as a gated recurrent unit (GRU). The CNN may perform a spatial pattern recognition on the user action data to identify different user interface elements interacted with by different users. The GRU may perform a temporal sequence analysis on the user action data to understand the sequence of actions performed by different users. In this manner, the disclosed hybrid neural network allows for a detailed analysis of the user action data in both the spatial dimension (e.g., what portions of the user interface are utilized) and the temporal dimension (e.g., the order of actions).

The disclosed techniques include dynamically updating the knowledge graph based on the user action data. In this manner, the knowledge graph may be up-to-date with user preferences and may therefore recommend navigation actions in the form of direct shortcuts (e.g., single user interface element) for performing a specific task and/or recommend optimized navigation paths within the user interface that preemptively align with user preferences and task objectives.

In some embodiments, the knowledge graph may be dynamically updated by adjusting one or more weights associated with one or more edges of the knowledge graph based on the user action data. For instance, the user action data may indicate that a particular navigation path of the user interface is rarely used. The knowledge graph may therefore be dynamically updated to adjust (e.g., decrease) a weight associated with an edge of the knowledge graph that connects two or more nodes (e.g., user interface elements) of the knowledge graph that are associated with the particular navigation path that is rarely used. Conversely, the user action data may indicate that a particular navigation path of the user interface is frequently used by users using the software application to perform a specific task. Thus, the knowledge graph may be dynamically updated to adjust (e.g., increase) a weight associated with an edge of the knowledge graph that connects two or more nodes of the knowledge graph that are associated with the particular navigation path that users frequently use to perform the specific task. In some embodiments, knowledge graph weights may be determined and/or updated using the hybrid neural network, which may be provided with user action data as an input and which may output knowledge graph weights in response, based on the hybrid neural network's analysis of the user action data both spatially and temporally.

The disclosed techniques include determining a recommended navigation action based on the dynamically updated knowledge graph. For instance, intent of users of the software application may be predicted based on the dynamically updated knowledge graph and the recommended navigation action may be determined based on the predicted intent. As an example, the dynamically updated knowledge graph may indicate that certain users (e.g., financial analysts) of the software application often perform a specific task (e.g., generate a quarterly financial report) at a specific time or in a specific time period (e.g., at or within a threshold amount of time after the beginning of each quarter). Thus, a recommended navigation action for these users may include modifying the user interface at the specific time to include a single user interface element that the users may select to perform the specific task. In this manner, the single user interface element may allow the users to avoid selecting an inefficient sequence of user interface elements every time the user performs the specific task like in conventional user interfaces.

In some embodiments, the recommended navigation action may be provided as an input to a generative language processing machine learning model configured to generate natural language guidance for the recommended navigation action. Examples of the generative language processing machine learning model may include, without limitation, Chat Generative Pre-trained Transformer (GPT), Gemini, or any other suitable transformer-based large language model (LLM). When used in conjunction with the knowledge graph, the generative language processing machine learning model may be able to generate advice that is not just reactive but, in some instances, is anticipatory. By providing natural language guidance across a continuum-on time (as the user's need arises), near time (shortly before the need becomes apparent), and/or ahead of time (before the user is even aware of the need), the generative language processing machine learning model may provide robust navigational support within the user interface.

In some embodiments, the user may provide feedback on the recommended navigation action. For example, the user may provide feedback on the natural language guidance generated for the recommended navigation action and displayed for viewing by the user. For instance, the user may give the natural language guidance a low rating if the user was not able to follow the natural language guidance. Conversely, the user may give the natural language guidance a high rating if the user was able to follow the natural language guidance. In some embodiments, the feedback on the natural language guidance may be used to update the knowledge graph (e.g., to adjust knowledge graph weights). In this manner, future adjustments may be made to the knowledge graph based on the feedback so that the knowledge graph remains adaptive and user-centric.

Example aspects of the present disclosure provide numerous technical effects and benefits. For instance, by automatically recommending context-specific navigation actions within a user interface of a software application, navigation errors associated with users interacting with different user interface elements of the user interface to perform a particular task may be minimized (or at least reduced). In this manner, inefficient utilization of computing resources that occur as a result of such navigation errors may be minimized. Furthermore, by dynamically updating the knowledge graph of the user interface in real-time based on user interactions with the user interface, the dynamically updated knowledge graph may be used to predict intent of different users of the software application. In this manner, the disclosed techniques allow context-specific navigation actions to be preemptively recommended to users and therefore further minimizing (or at least reducing) the likelihood of navigation errors. Techniques described herein improve the functioning of a software application by proactively predicting and recommending optimal navigation paths through the software application, thereby improving the usability and efficiency of the application. Additionally, embodiments of the present disclosure improve a user interface of a software application by presenting recommended navigation paths at optimal times within the user interface (e.g., when a user is likely to have a particular intent), thereby enabling the user to more efficiently and effectively utilize the user interface to perform application functionality.

Dynamically updating weights of a knowledge graph as described herein, such as through the use of a hybrid neural network that performs both spatial analysis and temporal analysis of user action data, allows optimal navigation paths to be automatically determined through a process that produces accurate results due to robust analysis of data in different dimensions (e.g., space and time), and that is iteratively improved over time through a dynamic feedback loop. Thus, techniques described herein produce improved automated navigation recommendations as a result of particular technical processes that are well suited to the problem of automated navigation recommendations.

Example Computing Environment for Providing Context-Specific Recommended Navigation Actions within a User Interface of an Application

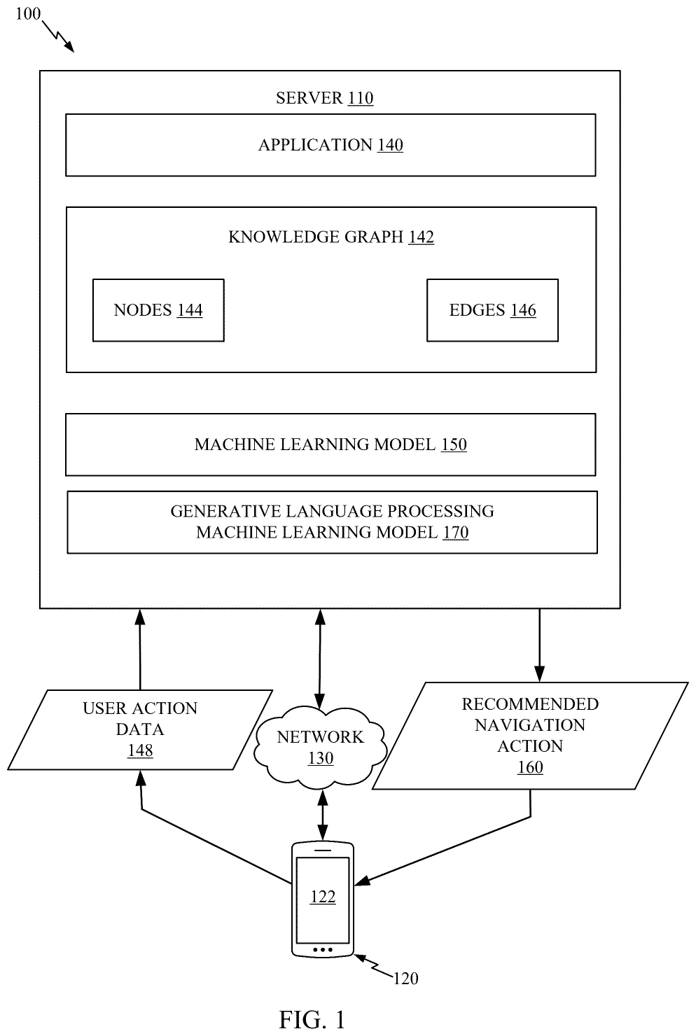

FIG. 1 depicts an example computing environment 100 for providing live support.

The computing environment 100 includes a server 110 and a client device 120 connected over a network 130. The network 130 may be representative of any type of connection over which data may be transmitted, such as a wide area network (WAN), local area network (LAN), cellular data network, and/or the like.

The server 110 generally includes a computing device, such as a server computer. The server 110 includes an application 140, which generally represents a computing application that a user interacts with over the network 130 via a user interface 122 of the application 140 that is displayed on the client device 120. In some embodiments, the application 140 may be a financial software application that users may use to perform different financial tasks, such as bookkeeping and invoice generation.

In some embodiments, the server 110 may include a knowledge graph 142 of the user interface 122. For example, the knowledge graph 142 may include a plurality of nodes 144 and a plurality of edges 146. Each of the plurality of nodes 144 may represent a different user interface element of the user interface 122. Furthermore, each of the plurality of edges 146 may represent a relationship between two or more nodes (e.g., user interface elements) of the plurality of nodes 144. In this manner, the knowledge graph 142 may represent the different user interface elements, functionalities, and user actions that may be performed with the user interface 122.

In some embodiments, a structure of the knowledge graph 142 may be defined by the following formula, where O represents the structure of the knowledge graph:

$$O = ( C , R , F )$$

wherein C denotes a comprehensive set of domain-specific building blocks (e.g., user interface elements of the user interface 122); R denotes the relationship among these concepts, and F is a set of functions delineating how these relationships interact. These components are integrated into a knowledge graph G:

$$G = ( V , E )$$

with V representing nodes that correspond to the concepts (e.g., user interface elements) and representing the edges that encode the relationships.

In some embodiments, the structure of the knowledge graph 142 may be analyzed through an adjacency matrix in which each element of the adjacency matrix reflects the existence of a relationship from one concept to another concept. In this manner, the adjacency matrix may facilitate the algorithmic identification of optimal paths and user intentions. Furthermore, search algorithms, such as Depth-First Search (DFS) or Breadth-First Search (BFS), having enhanced heuristic evaluations, may be implemented to forecast the most efficient paths towards achieving user objectives.

In some embodiments, path efficiency may be evaluated by a cost function that assigns a real number (e.g., cost) to each of the plurality of edges in the knowledge graph. More specifically, the cost associated with each respective edge of the knowledge graph may be assigned a positive number, a negative number, or zero in an attempt to quantify resources required for the respective edge which, as previously mentioned, may represent an interaction between two or more user interface elements of the user interface.

As illustrated, the server 110 may collect user action data 148 associated with the user interface 122. For example, in some embodiments, the user action data 148 may be collected continuously. Stated another way, user action data 148 may be generated each time a user interacts with the application 140 via the user interface 122 on the client device 120 and may be communicated to the server 110 via the network(s) 130.

In some embodiments, the user action data 148 may indicate different navigation paths (e.g., sequences of user interface elements) within the user interface 122 that users take to perform certain tasks within the application 140. For example, the user action data 148 may indicate that users commonly take a first navigation path within the user interface 122 to perform a first task and commonly take a second navigation path within the user interface 122 to perform a second task that is different from the first task.

In some embodiments, the server 110 may include a machine learning model 150. The user action data 148 may be provided as an input to the machine learning model 150. The machine learning model 150 may be configured to analyze the user action data 148 to identify patterns in how the user interface 122 is utilized by the different users. For instance, the machine learning model 150 may be configured to identify common tasks for which users use the application 140 based on the user action data 148.

In some embodiments, the machine learning model 150 may be configured to identify inefficiencies associated with how the user interface 122 is utilized to perform those common tasks the machine learning model 150 identified based on the user action data 148. For example, the machine learning model 150 may determine that a default navigation path of the user interface 122 that a majority of users take to perform a specific task (e.g., generate an automated report) may be inefficient compared to an alternative navigation path that exists within the user interface 122. More specifically, the alternative navigation path may include fewer user interface elements compared to the default navigation path.

The server 110 may be configured to dynamically update the knowledge graph 142 based, at least in part, on the user action data 148. For example, the machine learning model 150 may be configured to process the user action data 148 and output one or more adjusted weights for one or more edges of the knowledge graph 142. For instance, the machine learning model 150 may determine that a particular navigation within the user interface 122 is rarely used and therefore may output an adjusted weight for one or more edges of the knowledge graph that connects two or more nodes (e.g., user interface elements) of the knowledge graph 142 that are associated with the particular navigation path that is rarely used. The machine learning model 150 may determine that a different navigation path of the user interface 122 is frequently used by users to perform a specific task and therefore may output an adjusted weight for one or more edges of the knowledge graph 142 that connect two or more nodes of the knowledge graph 142 that are associated with the particular navigation path that users frequently use to perform the specific task.

The server may determine a recommended navigation action 160 for users of the application 140 based, at least in part, on the dynamically updated knowledge graph 142. For example, by dynamically updating the knowledge graph 142 based on the user action data 148, the knowledge graph 142 may represent (e.g., in real-time) how users interact with the application 140 and therefore the knowledge graph 142 may be used to predict the intent of users of the application 140. As an example, the dynamically updated knowledge graph 142 may indicate that certain users (e.g., financial analysts) of the application 140 perform a specific task (e.g., generate a quarterly financial report) at a specific time (e.g., at the beginning of each quarter). Thus, in some embodiments, the recommended navigation action 160 for these users may include modifying the user interface 122 at the specific time to include a single user interface element (e.g., shortcut) that the users may select to perform the specific task. In this manner, the single user interface element may allow the users to avoid selecting a sequence of user interface element every time the user performs the specific task like in conventional user interfaces.

In some embodiments, the recommended navigation action 160 provided to the client device 120 for viewing in the user interface 122 may include natural language guidance for performing the recommended navigation action 160. For instance, the recommended navigation action 160 determined from, at least in part, the dynamically updated knowledge graph 142 may be provided as an input to a generative language processing machine learning model 170. The generative language processing machine learning model 170 may be configured to generate natural language guidance for the recommended navigation action 160. For example, the recommended navigation action 160 may be for a user to take a particular navigation path within the user interface 122 and the natural language guidance generated by the generative language processing machine learning model 170 may, for example, include detailed instructions (e.g., step-by-step) for traversing the particular navigation path. The natural language guidance generated by the generative language processing machine learning model 170 may be displayed in the user interface 122 for viewing by the user.

### Example Block Diagram of Components for Automatically Recommending Navigation Actions in a User Interface of an Application

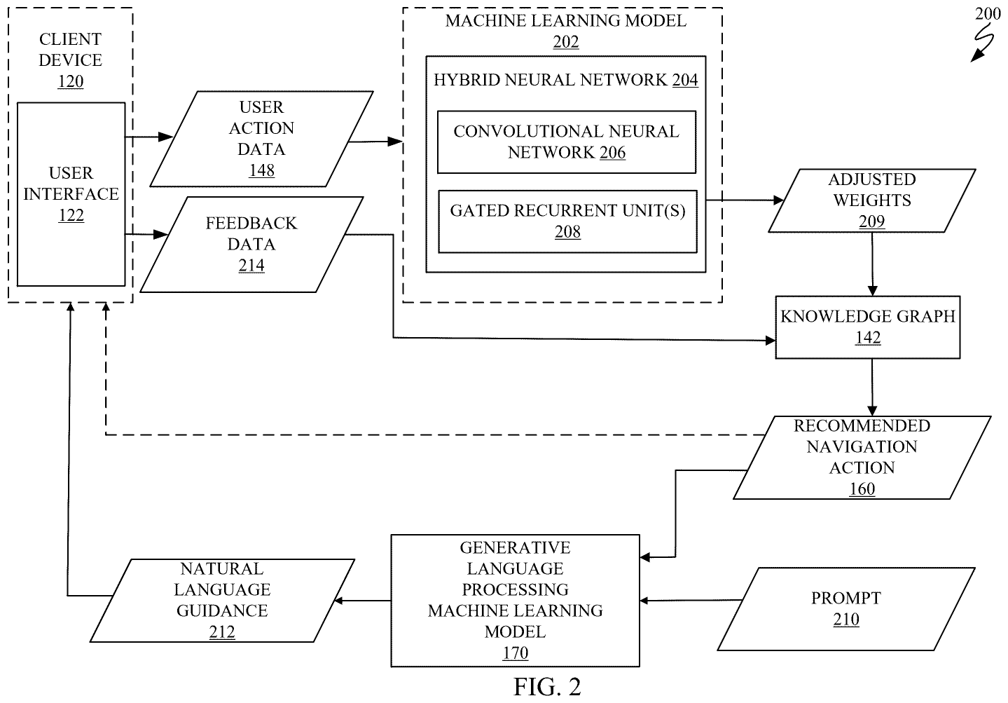

FIG. 2 is a block diagram of components of a system 200 for automatically recommending navigation actions within a user interface of an application according to some embodiments of the present disclosure.

As illustrated, the system 200 may include a machine learning model 202. The machine learning model 202 may be configured to receive the user action data 152 from the client device 120. Similar to the machine learning model 150 discussed above with reference to FIG. 1, the machine learning model 202 of FIG. 2 may be configured to analyze the user action data 148 to identify patterns in how the user interface 122 is utilized by the different users. For instance, the machine learning model 202 model may be configured to identify common tasks for which users use the application 140 (FIG. 1) based on the user action data 148.

In some embodiments, the machine learning model 150 may be a hybrid neural network 204. As illustrated, the hybrid neural network 204 may include a convolutional neural network (CNN) 206 and a gated recurrent unit (GRU) 208. The CNN 206 may perform a spatial pattern recognition on the user action data 148 to identify different user interface elements of the user interface 122 that are interacted with by different users. The GRU 208 may perform a temporal sequence analysis on the user action data 148 to understand the sequence of actions performed by different users. In this manner, the disclosed hybrid neural network 204 allows for a detailed analysis of the user action data 148 in both the spatial dimension (e.g., what portions of the user interface are utilized) and the temporal dimension (e.g., the order of actions).

As illustrated, the machine learning model 202 may output one or more adjusted weights 209 for the knowledge graph 142 based, at least in part, on the user action data 148. More specifically, the one or more adjusted weights 209 may be for one or more edges of the plurality of edges 146 (FIG. 1) of the knowledge graph 142. For instance, the machine learning model 202 may determine that a particular navigation within the user interface 122 is rarely used and therefore may output an adjusted weight for one or more edges of the knowledge graph 142 that connects two or more nodes (e.g., user interface elements) of the knowledge graph 142 that are associated with the particular navigation path that is rarely used. The machine learning model 202 may also determine that a different navigation path of the user interface 122 is frequently used by users to perform a specific task and therefore may output an adjusted weight for one or more edges of the knowledge graph 142 that connect two or more nodes of the knowledge graph 142 that are associated with the particular navigation path that users frequently use to perform the specific task.

In some embodiments, hybrid neural network 204 (or, more generally, machine learning model 202) has been trained through a supervised learning process based on labeled training data indicating optimal navigation paths for user interface 122 (e.g., for particular tasks), which may be generated based on review of navigation data by experts and/or based on automated analysis of navigation data to determine most efficient paths through the user interface. For example, a supervised learning process may involve providing training inputs (e.g., a set of user action data) as inputs to hybrid neural network 204. Hybrid neural network 204 processes the training inputs though convolutional neural network 206 and gated recurrent unit(s) 208 and produces outputs (e.g., knowledge graph weights) based on the training inputs. The outputs are compared to the labels associated with the training inputs (e.g., indicating optimal navigation path(s) through the user interface) to determine the accuracy of the model predictions (e.g., if the output weights are consistent with the optimal navigation path(s) indicated in the training data labels), and parameters of hybrid neural network 204 are iteratively adjusted until one or more conditions are met. For instance, the one or more conditions may relate to an objective function (e.g., a cost function or loss function) for optimizing one or more variables (e.g., relating to model accuracy). In some embodiments, the conditions may relate to whether the predictions produced by the model based on the training inputs match the labels associated with the training inputs or whether a measure of error between training iterations is not decreasing or not decreasing more than a threshold amount. The conditions may also include whether a training iteration limit has been reached. Parameters adjusted during training may include, for example, hyperparameters, values related to numbers of iterations, weights, functions used by nodes to calculate scores, and the like. In some embodiments, validation and testing are also performed for a machine learning model, such as based on validation data and test data, as is known in the art. It is noted that the user action data included in the training data may include clickstream data, date and time information, user attributes, device attributes, application attributes, and/or the like. Thus, the weights output by hybrid neural network 204 may be based on actions as well as other contextual information such as a user's profession, industry, length of use of the application, skill(s), the date(s) and/or time(s) associated with given activities, the type of device (e.g., smartphone, laptop, desktop, tablet, and/or the like) being used to perform activities, the type of application (e.g., web application or standalone application) being used to perform the activities, the task that the user intends to perform (e.g., which may be inferred based on other contextual data and/or action data), and/or the like.

In some embodiments, machine learning model 202 is used to generate knowledge graph weights for each individual user at a given time based on that user's action data (e.g., up to the time at which the weights are being generated, such as a threshold amount of past action data and/or action data from a threshold amount of time prior to the time at which the weights are being generated). Thus, the action data for a user may be provided to machine learning model 202, which may output knowledge graph weights for that user in that particular context (e.g., having particular user attributes, having a particular intent such as to perform a particular task, using a particular device/application and/or device/application type, at a particular date and/or time, after having performed particular actions), and those knowledge graph weights may be used to determine a navigation path to recommend to the user in that context.

As illustrated, the dynamically updated knowledge graph 142 may be used to recommend the navigation action 160 for users using the application 140. In some embodiments, the recommended navigation action 160 may be provided directly to the client device 120. For example, the recommended navigation action 10 may include modifying the user interface 122. More specifically, the recommended navigation action 160 may include displaying a single user interface element within the user interface 122 that allows a user to perform a specific task by selecting (e.g., clicking) the single user interface element. In this manner, the user may perform the specific task without having to select multiple user interface elements in a particular sequence like in conventional user interfaces. Thus, by consolidating the user interface elements the user must select to perform the specific task to the single user interface element, the recommended navigation action 160 may minimize (or at least reduce) the likelihood of the user committing a navigation error while performing the specific task.

In some embodiments, the recommended navigation action 160 may not include modifying the user interface to include a single user interface element that a user may select to perform the specific task. For example, in some embodiments, the recommended navigation action 160 may be a particular navigation path within the user interface 122 that the dynamically updated knowledge graph 142 determined is the most efficient navigation path for performing a specific task. In such embodiments, the recommended navigation action 160 (that is, the particular navigation path) may be provided as an input to the generative language processing machine learning model 170.

In some embodiments, the generative language processing machine learning model 170 may also receive a prompt 210 as an input. The prompt 210 may, for example, include natural language text explaining what the generative language processing machine learning model 170 should do with the recommended navigation action 160. For instance, the prompt 210 may instruct the generative language processing machine learning model 170 to generate natural language guidance 212 indicative of the recommended navigation action 160. As an example, the natural language guidance 212 the generative language processing machine learning model 170 generates for the recommended navigation action 160 may include step-by-step instructions for how the user may traverse the particular navigation path within the user interface 122 that allows the user to perform the specific task in the most efficient manner (e.g., selecting the fewest number of user interface elements possible).

In some embodiments, the user may provide feedback data 214 on the recommended navigation action 160 or the natural language guidance 212. For example, the user may give the recommended navigation action 160 or natural language guidance 212 a low rating if the user did not find the recommended navigation action 160 or natural language guidance 212 helpful. Conversely, the user may give the recommended navigation action 160 or natural language guidance 212 a high rating if the user found the recommended navigation action 160 or natural language guidance 212 to be helpful.

In some embodiments, the feedback data 214 on the recommended navigation action 160 (e.g., the single user interface element displayed on the user interface 122) may be provided to the knowledge graph 142. In this manner, the knowledge graph 142 may learn from the feedback data 214 and adjust the recommended navigation action 160 as needed. More specifically, the feedback data 214 informs future adjustments to the knowledge graph and ensures the system 200 remains adaptive and user-centric.

Example Operations for Automatically Recommending Navigation Actions within a User Interface of an Application

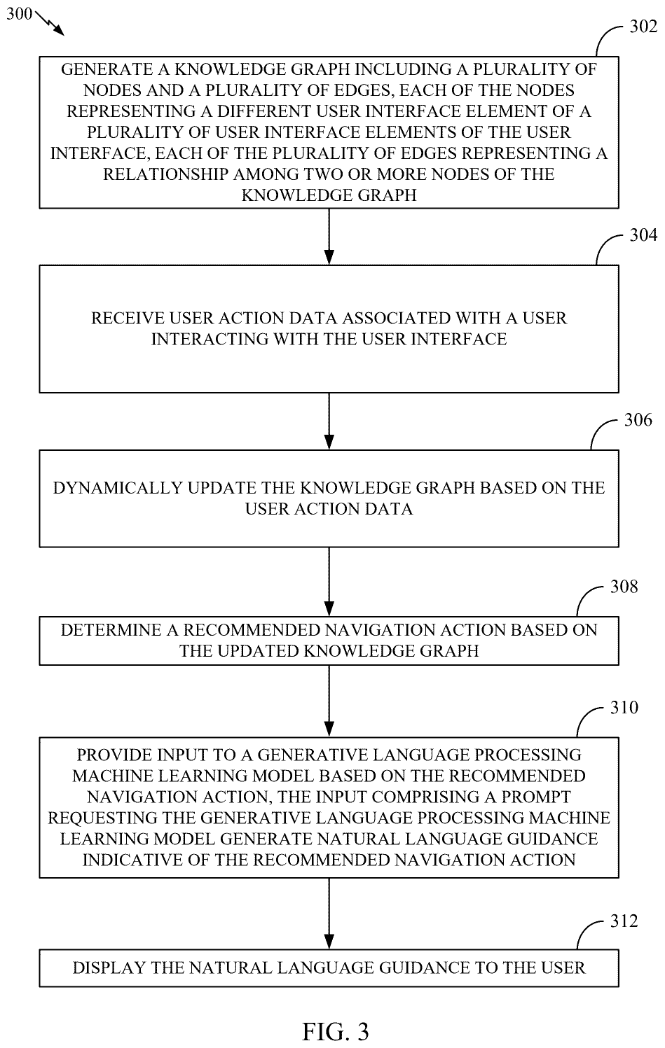

FIG. 3 is a flow diagram of an example operations 300 for automatically recommending navigation actions within a user interface of an application according to some embodiments of the present disclosure. The operations 300 may be performed by instructions executing on a processor of a server (such as the server 110 of FIG. 1).

Operation 302 includes generating a knowledge graph comprising a plurality of nodes and a plurality of edges, each of the plurality of nodes representing a different user interface element of the plurality of user interface elements, each of the plurality of edges representing a relationship among two or more nodes of the knowledge graph.

Operation 304 includes receiving user action data associated with a user interacting with one or more user interface elements of the plurality of user interface elements of the user interface. For instance, the user action data may include clickstream data indicative of the different user interface elements users select (e.g., click) while interacting with the application via the user interface.

Operation 306 includes dynamically updating the knowledge graph based on the user action data. For example, in some embodiments, dynamically updating the knowledge graph may include adjusting one or more weights associated with one or more edges of the plurality of edges of the knowledge graph generated at operation 302.

In some embodiments, dynamically updating the knowledge graph at operation 306 may include providing the user action data as an input to a machine learning model (e.g., the machine learning model 150 illustrated in FIG. 1 or the machine learning model illustrated in FIG. 2) configured to analyze the user action data to determine an adjustment to one or more weights associated with one or more edges of the plurality of edges of the knowledge graph. Furthermore, dynamically updating the knowledge graph at operation 306 may include obtaining the adjustment to the one or more weights as an output of the machine learning model and may further include dynamically updating the knowledge graph based on the adjustment.

Operation 308 includes determining a recommended navigation action based on the updated knowledge graph;

Operation 310 includes providing input to a generative language processing machine learning model based on the recommended navigation action, the input comprising a prompt requesting the generative language processing machine learning model generate natural language guidance indicative of the recommended navigation action.

Operation 312 includes displaying the natural language guidance to the user. For example, the natural language guidance may be displayed on the user interface. In some embodiments, the natural language guidance may be displayed as a pop-up notification in the user interface. By displaying the natural language guidance within the user interface, the user follow the natural language guidance to navigate the user interface as recommended to accomplish the specific task in the most efficient manner and therefore reducing the likelihood of navigation errors that, as discussed above, can result in inefficient utilization of computing resources by, for example, needlessly displaying pages of the user interface that are not relevant to the specific task the user is trying to accomplish.

In certain embodiments, the operations 300 may include receiving feedback data on the natural language guidance. For instance, a user using the user interface may provide feedback indicative of whether the natural language guidance generated at operation 310 was helpful or not. In certain embodiments, the operations 300 may further include updating the knowledge graph based on the feedback data. In this manner, the feedback data may inform future adjustments to the knowledge graph to ensure the knowledge graph remains adaptive and user-centric.

### Example Computing Systems

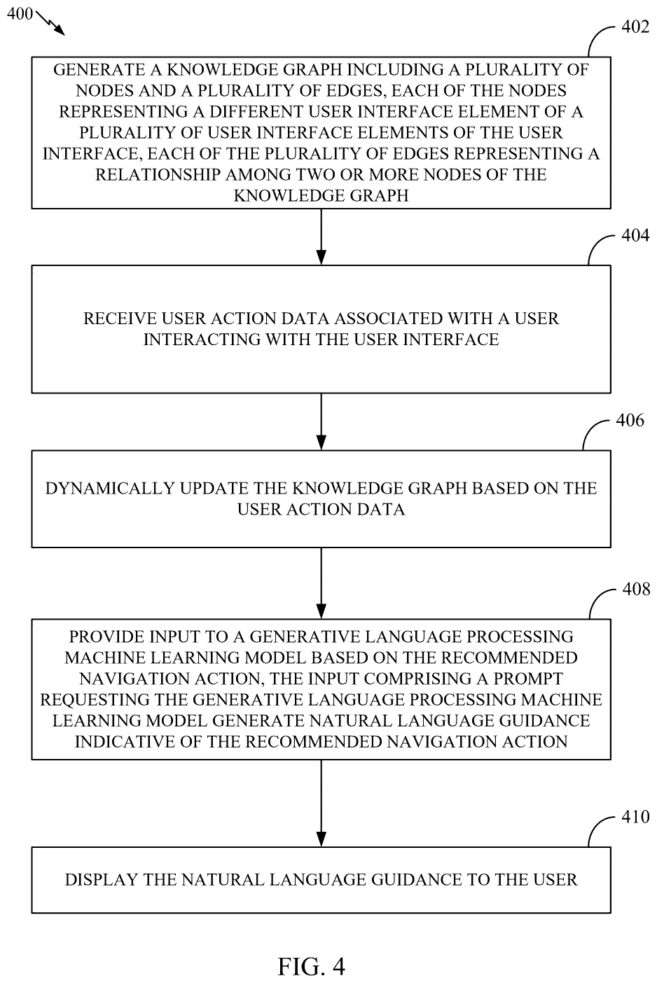

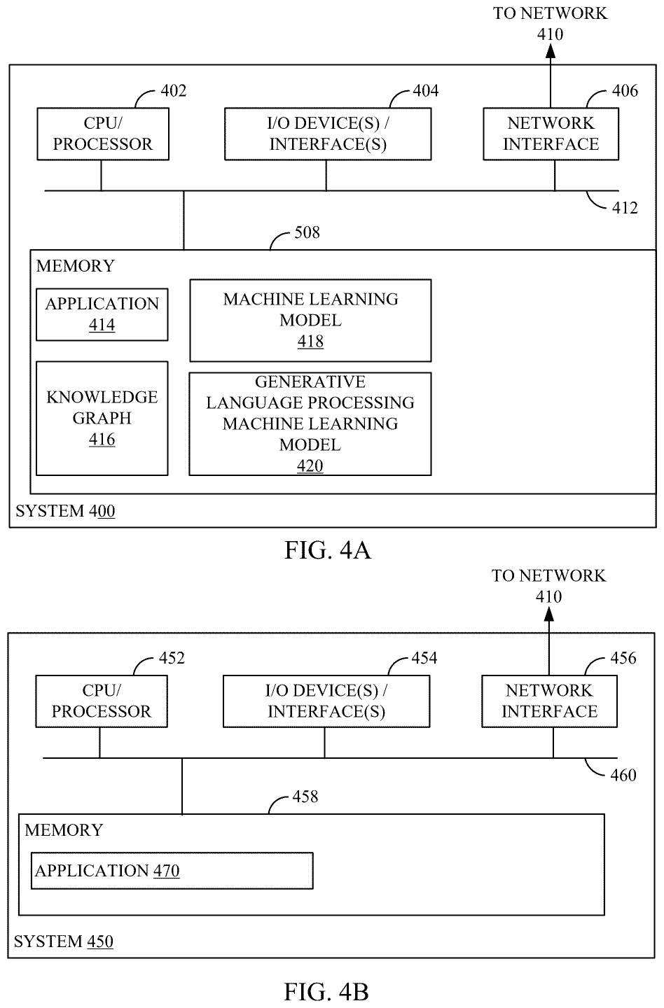

FIG. 4A illustrates an example computing system 400 with which embodiments of the disclosure related to automatically recommending navigation actions within a user interface of an application may be implemented. For example, the computing system 400 may be representative of the server 110 of FIG. 1.

The computing system 400 includes a central processing unit (CPU) 402, one or more I/O device interfaces 404 that may allow for the connection of various I/O devices 404 (e.g., keyboards, displays, mouse devices, pen input, etc.) to the computing system 400, a network interface 406, a memory 408, and an interconnect 412. It is contemplated that one or more components of the computing system 400 may be located remotely and accessed via a network 410. It is further contemplated that one or more components of the computing system 500 may include physical components or virtualized components.

The CPU 402 may retrieve and execute programming instructions stored in the memory 408. Similarly, the CPU 402 may retrieve and store application data residing in the memory 408. The interconnect 412 transmits programming instructions and application data, among the CPU 402, the I/O device interface 404, the network interface 406, the memory 408. The CPU 402 is included to be representative of a single CPU, multiple CPUs, a single CPU having multiple processing cores, and other arrangements.

Additionally, the memory 408 is included to be representative of a random access memory or the like. In some embodiments, the memory 408 may include a disk drive, solid state drive, or a collection of storage devices distributed across multiple storage systems. Although shown as a single unit, the memory 408 may be a combination of fixed and/or removable storage devices, such as fixed disc drives, removable memory cards or optical storage, network attached storage (NAS), or a storage area-network (SAN).

As shown, the memory 408 includes application 414, knowledge graph 416, machine learning model 418, and generative language processing machine learning model 420, which may be representative of application 140, knowledge graph 142, machine learning model 150, and generative language processing machine learning model of FIGS. 1 and 2.

FIG. 4B illustrates an example computing system 450 with which embodiments of the disclosure related to automatically recommending a navigation action within a user interface of an application may be implemented. For example, the computing system 450 may be representative of the client device 120 of FIG. 1.

The computing system 450 includes a central processing unit (CPU) 452, one or more I/O device interfaces 454 that may allow for the connection of various I/O devices 454 (e.g., keyboards, displays, mouse devices, pen input, etc.) to the computing system 450, a network interface 456, a memory 458, and an interconnect 460. It is contemplated that one or more components of the computing system 450 may be located remotely and accessed via the network 410. It is further contemplated that one or more components of the computing system 450 may include physical components or virtualized components.

The CPU 452 may retrieve and execute programming instructions stored in the memory 458. Similarly, the CPU 452 may retrieve and store application data residing in the memory 558. The interconnect 460 transmits programming instructions and application data, among the CPU 452, the I/O device interface 454, the network interface 456, the memory 458. The CPU 452 is included to be representative of a single CPU, multiple CPUs, a single CPU having multiple processing cores, and other arrangements.

Additionally, the memory 458 is included to be representative of a random access memory or the like. In some embodiments, the memory 458 may include a disk drive, solid state drive, or a collection of storage devices distributed across multiple storage systems. Although shown as a single unit, the memory 458 may be a combination of fixed and/or removable storage devices, such as fixed disc drives, removable memory cards or optical storage, network attached storage (NAS), or a storage area-network (SAN). As shown, the memory 458 may include an application 470, such as the application 140 discussed above with reference to FIG. 1.

### Additional Considerations

The preceding description provides examples, and is not limiting of the scope, applicability, or embodiments set forth in the claims. Changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The preceding description is provided to enable any person skilled in the art to practice the various embodiments described herein. Various modifications to these embodiments will be readily apparent to those skilled in the art, and the generic principles defined herein may be applied to other embodiments. For example, changes may be made in the function and arrangement of elements discussed without departing from the scope of the disclosure. Various examples may omit, substitute, or add various procedures or components as appropriate. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and other operations. Also, “determining” may include receiving (e.g., receiving information), accessing (e.g., accessing data in a memory) and other operations. Also, “determining” may include resolving, selecting, choosing, establishing and other operations.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The various illustrative logical blocks, modules and circuits described in connection with the present disclosure may be implemented or performed with a general purpose processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

A processing system may be implemented with a bus architecture. The bus may include any number of interconnecting buses and bridges depending on the specific application of the processing system and the overall design constraints. The bus may link together various circuits including a processor, machine-readable media, and input/output devices, among others. A user interface (e.g., keypad, display, mouse, joystick, etc.) may also be connected to the bus. The bus may also link various other circuits such as timing sources, peripherals, voltage regulators, power management circuits, and other types of circuits, which are well known in the art, and therefore, will not be described any further. The processor may be implemented with one or more general-purpose and/or special-purpose processors. Examples include microprocessors, microcontrollers, DSP processors, and other circuitry that can execute software. Those skilled in the art will recognize how best to implement the described functionality for the processing system depending on the particular application and the overall design constraints imposed on the overall system.

If implemented in software, the functions may be stored or transmitted over as one or more instructions or code on a computer-readable medium. Software shall be construed broadly to mean instructions, data, or any combination thereof, whether referred to as software, firmware, middleware, microcode, hardware description language, or otherwise. Computer-readable media include both computer storage media and communication media, such as any medium that facilitates transfer of a computer program from one place to another. The processor may be responsible for managing the bus and general processing, including the execution of software modules stored on the computer-readable storage media. A computer-readable storage medium may be coupled to a processor such that the processor can read information from, and write information to, the storage medium. In the alternative, the storage medium may be integral to the processor. By way of example, the computer-readable media may include a transmission line, a carrier wave modulated by data, and/or a computer readable storage medium with instructions stored thereon separate from the wireless node, all of which may be accessed by the processor through the bus interface. Alternatively, or in addition, the computer-readable media, or any portion thereof, may be integrated into the processor, such as the case may be with cache and/or general register files. Examples of machine-readable storage media may include, by way of example, RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The machine-readable media may be embodied in a computer-program product.

A software module may comprise a single instruction, or many instructions, and may be distributed over several different code segments, among different programs, and across multiple storage media. The computer-readable media may comprise a number of software modules. The software modules include instructions that, when executed by an apparatus such as a processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module, it will be understood that such functionality is implemented by the processor when executing instructions from that software module.

The following claims are not intended to be limited to the embodiments shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A method for automatically recommending navigation actions within a user interface of a software application, the method comprising:
generating a knowledge graph comprising a plurality of nodes and a plurality of edges, each of the plurality of nodes representing a different user interface element of a plurality of user interface elements of the user interface, each of the plurality of edges representing a relationship among two or more nodes of the knowledge graph;
receiving user action data associated with a user interacting with the user interface;
dynamically updating the knowledge graph based on the user action data;
determining a recommended navigation action based on the dynamically updated knowledge graph;
providing input to a generative language processing machine learning model based on the recommended navigation action, the input comprising a prompt requesting the generative language processing machine learning model generate natural language guidance indicative of the recommended navigation action; and
displaying the natural language guidance to the user.

2. The method of claim 1, further comprising:
receiving feedback data from the user regarding the natural language guidance; and
updating the knowledge graph based on the feedback data.

3. The method of claim 1, wherein the user action data comprises a sequence of user interface elements with which the user interacted.

4. The method of claim 1, wherein dynamically updating the knowledge graph comprises adjusting one or more weights associated with one or more edges of the plurality of edges of the knowledge graph.

5. The method of claim 1, wherein dynamically updating the knowledge graph comprises:
providing the user action data as an input to a machine learning model configured to analyze the user action data to determine an adjustment to one or more weights associated with one or more edges of the plurality of edges of the knowledge graph;
obtaining the adjustment to the one or more weights as an output of the machine learning model; and
dynamically updating the knowledge graph based on the adjustment.

6. The method of claim 5, wherein the machine learning model comprises a hybrid neural network comprising a convolutional neural network configured to analyze the user action data in a spatial dimension and a gated recurrent unit configured to analyze the user action data in a temporal dimension.

7. The method of claim 1, wherein the generative language processing machine learning model comprises a large language model.

8. The method of claim 1, wherein:
the recommended navigation action comprises a particular navigation path within the user interface for causing the software application to perform a specific task; and
the natural language guidance comprises step-by-step instructions on how to traverse the particular navigation path within the user interface.

9. The method of claim 8, wherein the particular navigation path includes fewer user interface elements than any other navigation path within the user interface and associated with performing the specific task.

10. A system for automatically recommending context-specific navigation actions in a user interface of a software application, the system comprising:
one or more processors; and
one or more memory configured to store computer executable instructions that, when executed by the one or more processors, cause the one or more processors to:
generate a knowledge graph comprising a plurality of nodes and a plurality of edges, each of the plurality of nodes representing a different user interface element of a plurality of user interface elements of the user interface, each of the plurality of edges representing a relationship among two or more nodes of the knowledge graph;
receive user action data associated with a user interacting with the user interface;
dynamically update the knowledge graph based on the user action data;
determine a recommended navigation action based on the dynamically updated knowledge graph;
provide input to a generative language processing machine learning model based on the recommended navigation action, the input comprising a prompt requesting the generative language processing machine learning model generate natural language guidance indicative of the recommended navigation action; and
display the natural language guidance to the user.

11. The system of claim 10, wherein the computer executable instructions, when executed by the one or more processors, further cause the one or more processors to:
receive feedback data from the user regarding the natural language guidance; and
update the knowledge graph based on the feedback data.

12. The system of claim 10, wherein to dynamically update the knowledge graph, the one or more processors adjust one or more weights associated with one or more edges of the plurality of edges of the knowledge graph.

13. The system of claim 10, wherein to dynamically update the knowledge graph, the one or more processors:
provide the user action data as an input to a machine learning model configured to analyze the user action data to determine an adjustment to one or more weights associated with one or more edges of the plurality of edges of the knowledge graph;
obtain the adjustment to the one or more weights as an output of the machine learning model; and
dynamically update the knowledge graph based on the adjustment.

14. The system of claim 13, wherein the machine learning model comprises a hybrid neural network comprising a convolutional neural network configured to analyze the user action data in a spatial dimension and a gated recurrent unit configured to analyze the user action data in a temporal dimension.

15. The system of claim 10, wherein the generative language processing machine learning model comprises a large language model.

16. The system of claim 10, wherein:
the recommended navigation action comprises a particular navigation path within the user interface for causing the software application to perform a specific task; and
the natural language guidance comprises step-by-step instructions on how to traverse the particular navigation path within the user interface.

17. The system of claim 16, wherein the particular navigation path includes fewer user interface elements than any other navigation path within the user interface and associated with performing the specific task.

18. A non-transitory computer-readable medium comprising instructions to be executed in a computer system for real-time masking of sensitive information in content shared during a screen share session of a video call, wherein the instructions, when executed in the computer system, cause the computer system to:
generate a knowledge graph comprising a plurality of nodes and a plurality of edges, each of the plurality of nodes representing a different user interface element of a plurality of user interface elements of the user interface, each of the plurality of edges representing a relationship among two or more nodes of the knowledge graph;
receive user action data associated with a user interacting with the user interface;
dynamically update the knowledge graph based on the user action data;
determine a recommended navigation action based on the dynamically updated knowledge graph;
provide input to a generative language processing machine learning model based on the recommended navigation action, the input comprising a prompt requesting the generative language processing machine learning model generate natural language guidance indicative of the recommended navigation action; and
display the natural language guidance to the user.

19. The non-transitory computer-readable medium of claim 18, wherein the instructions, when executed, in the computer system, cause the computer system to:
receive feedback data from the user regarding the natural language guidance; and
update the knowledge graph based on the feedback data.

20. The non-transitory computer-readable medium of claim 18, wherein to dynamically update the knowledge graph based on the user action data, one or more weights associated with one or more edges of the plurality of edges of the knowledge graph are adjusted.
